(19) United States
(12) Patent Application Publication
(10) Pub. No.: US 2019/0377075 A1
(43) Pub. Date: Dec. 12, 2019

(54) COMMUNICATION SCANNING METHOD AND SYSTEM

(71) Applicant: Intel IP Corporation, Santa Clara, CA (US)

(72) Inventors: Yossi Tsfati, Rishon Le Zion (IL); Igal Kushnir, Hod-Hasharon (IL); Naom Kogan, Tel-Aviv, Ta (IL)

(21) Appl. No.: 16/466,759

(22) PCT Filed: Dec. 29, 2016
(86) PCT No.: PCT/US2016/069212

§ 371 Date: Jun. 5, 2019

(51) Int. Cl. G01S 13/04; G01S 7/00

(52) U.S. Cl. CPC G01S 13/04; G01S 2013/0254; G01S 7/006

(57) ABSTRACT

An apparatus of a wireless communication device can include radar circuitry and communication circuitry. The radar circuitry can perform one or more proximity measurements. The radar circuitry can detect whether an object is near the apparatus that may affect one or more beamforming scanning operations or affect one or more communication of the apparatus utilizing the one or more beamforming scanning operations based on the one or more proximity measurements. The communication apparatus can adjust one or more beamforming scanning operations based on the one or more proximity measurements and perform the adjusted one or more beamforming scanning operations to reduce beamforming scanning time and/or scanning resources.

### BACKGROUND

### Field

Aspects described herein generally relate to communication scanning methods and systems, including using proximity detection to reduce scanning time and/or scanning resources.

### Related Art

Wireless communications are expanding into communications having increased data rates (e.g., from Institute of Electrical and Electronics Engineers (IEEE) 802.11a/g to IEEE 802.11n to IEEE 802.11ac and beyond). Currently, fifth generation (5G) cellular communication and Wireless Gigabit Alliance (WiGig) standards are being introduced for wireless cellular devices and Wireless Local Area Networks (WLAN), respectively. In high-density deployment situations, the utilization of available bandwidth becomes increasingly important. Already, there are methods of multiple access which allocate by frequency, time and code; Time Division Multiple Access (TDMA), Frequency Division Multiple Access (FDMA) and Code Division Multiple Access CDMA. A further method of multiple access is available by position, displacement or space. For example, the cellular system allows frequency re-use by mobile devices operating in different cells separated by a certain distance (usually the cell adjacent to an adjacent cell). Another method of Space Division Multiple Access (SDMA) is by using

Communications systems can include methods for multiple access based on position, displacement and/or space. For example, a cellular system can allow frequency re-use by communication devices operating in different cells separated by a sufficient distance. Another method of Space Division Multiple Access (SDMA) can be used in devices having multiple antennas and directional antennas. For example, phased array antenna systems allow a device to electronically control the direction of transmitted power or the direction in which an antenna is sensitive. Since the direction is electronically variable, the direction can be configured for a variety of environments.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIGS. 1, 2A, and 2B illustrate a communication device or station (STA) according to an exemplary aspects of the present disclosure.

FIGS. 3, 4A, and 4B illustrate remote front end modules (RFEMs) according to exemplary aspects of the present disclosure.

FIG. 5A illustrates a remote front end module (RFEM) including a radar system and circuitry for radio frequency (RF) conversion to/from an intermediate frequency (IF) according to exemplary aspects of the present disclosure.

FIG. 5B illustrates a remote front end module (RFEM) including a radar system and circuitry for radio frequency (RF) conversion to/from an intermediate frequency (IF) according to exemplary aspects of the present disclosure.

FIG. 6 illustrates a baseband transceiver for a remote front end module (RFEM) including circuitry for IF conversion to/from a baseband frequency (BF) according to an exemplary aspect of the present disclosure.

FIGS. 7 and 8 illustrate radar systems according to exemplary aspects of the present disclosure.

FIG. 9 illustrates a scanning method according to exemplary aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Aspects of the present disclosure relate to one or more systems, devices, apparatus, assemblies, methods, and/or computer readable media configured to enhance wireless communications, including communication systems and methods using antenna modules having multiple antenna elements, such as phased array antennas.

Phased array communication systems can include an array of antennas to steer the transmit signal in particular direction. The directional control is achieved by phase shifting the signal to each antenna so that in a certain direction, the transmitted signals add coherently or constructively. In other directions, the transmitted signals add destructively, and the radiated power in those directions is reduced or eliminated. In this way, the radiated energy can be focused and directionally controlled towards the target (e.g., a receiver).

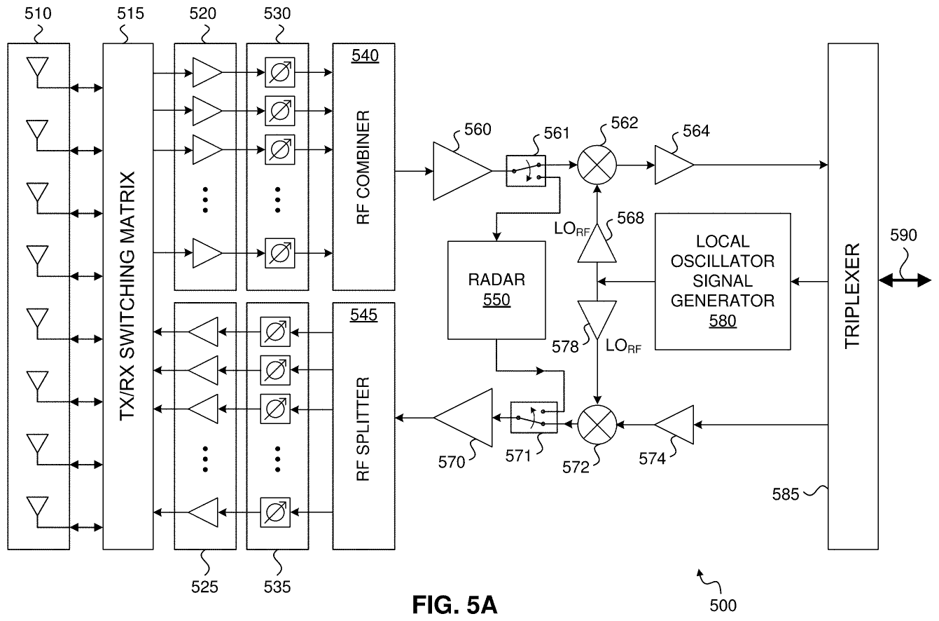

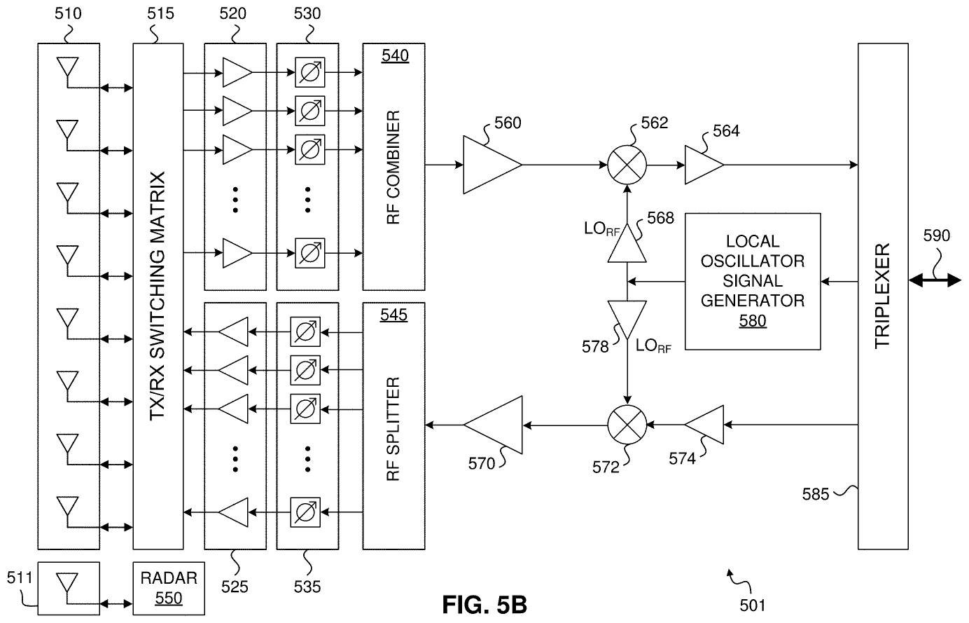

In a similar way, received signals from each antenna are phase shifted such that the signals add constructively when received from one direction, and the signals add destructively when received from another direction. It is the combination of the phase shift incurred by the difference in path delay between antennas and the phase shift introduced by the phase shifters that determine whether a signal in a particular direction is constructively or destructively added. In this operation, the directionality of the antenna can be adjusted by changing the phase delay introduced by each phase shifter. The phased array antenna system can be configured as a directional antenna in which the directivity of the antenna can be electronically altered or controlled. As illustrated in, for example, FIGS. 5A and 5B, systems can include additional antenna elements within a phased array antenna, a plurality of amplifiers (e.g., LNAs or PAs), a plurality of variable phase shifters along with a power splitter on the transmit side and a power combiner to add the signals on the receive side. Control and additional circuit components can be incorporated into a communication Radio Frequency Integrated Circuit (RFIC) making this a practical and beneficial method to implement a wireless communication system.

As an overview, communication systems and methods according to the present disclosure include the controlling of beamforming scanning/searching for multi-antenna systems such as systems with phased array antennas. In operation, beamforming scanning is performed to determine appropriate antennas of a multi-antenna antenna module to use for wireless communications that utilize beamforming.

Mobile devices and other communication systems can implement multiple antenna modules (that each can have multiple antenna elements) to increase diversity and link budget. Although the use of multiple antenna modules can reduce a possible impact on communications due to one or more antenna modules (or one or more antenna elements of a particular module) being blocked by an object such as the human body of the user of the mobile device, a blocked antenna module (or blocked antenna elements of the module) can impact one or more beamforming scanning operations and/or ultimately result in such operations having been unnecessarily performed. For example, if an antenna module is blocked, the preference to utilize the blocked antenna module for communications is significantly reduced or the use is otherwise avoided. In this scenario, the previous beamforming scanning operations for the blocked antenna module performed in preparation of the communications would be unnecessarily performed as the blocked antenna module would likely not have been used for the communication operations.

The communication system and methods can include aspects for determining the location of a blocking object and/or or person to facilitate communications, including improving the scanning time and utilization of scanning resources for a remote front end module (RFEM) having one or more phased array antenna modules. For example, the present disclosure includes the selective scanning of the antenna elements of the RFEM based on the detection of one or more blocking objects/people using one or more proximity detectors. The selective scanning based on the proximity detection can improve (e.g., reduce) the scanning time and/or scanning resources necessary to facilitate communications using one or more RFEMs.

In exemplary aspects, beamforming scanning operations and the selection of particular antenna elements of one or more RFEMs to perform the scanning operations are controlled based on the detection of objects in proximity of the antenna module that may block the antenna module. By controlling which antenna elements and/or which RFEMs are used for beamforming scanning, unnecessary scanning operations can be reduced and/or avoided. Further, the control of the scanning operations can reduce the time and/or resources required for the beamforming scanning operations by partially or completely disabling scanning operations for antenna elements and/or RFEMs (having multiple antenna elements) that have been determined to be blocked by an object (e.g., user of the module device).

For example, an RFEM may include, for example, 8 antennas (also referred to as antenna elements) and 8 phase shifters, with 4 possibilities for each phase shifter. For a mobile device having, for example, 6 RFEMs, the scanning combinations will have 4^{(8×6)}≅7.92e²⁸ possibilities. By partially or completely disabling scanning operations for antenna elements and/or RFEMs that have been determined to be blocked by an object, the scanning combinations can be reduced so as to reduce the time and/or resources required for the beamforming scanning operations.

In an exemplary aspect, the mobile device (or the RFEM of the mobile device) can be configured to determine the presence of a proximate object and adjust or alter one or more characteristics of the beamforming scanning operations for one or more RFEMs (e.g., the duration of the scan, directions at which the scanning is performed, antenna elements to include in the scanning operations, RFEMs to include/exclude from the scanning operations, power of the radiated signals used in the scanning operations, etc.) based on the determination. In an exemplary aspect, the mobile device is configured to adjust or alter the radiated power based on the proximity determination. Upon the detection of an object (e.g., blocking object or person), the mobile device (or one or more specific RFEMs) can be configured to change the direction of the phased array antenna or re-distribute the transmit power to different RFEMs that are not blocked.

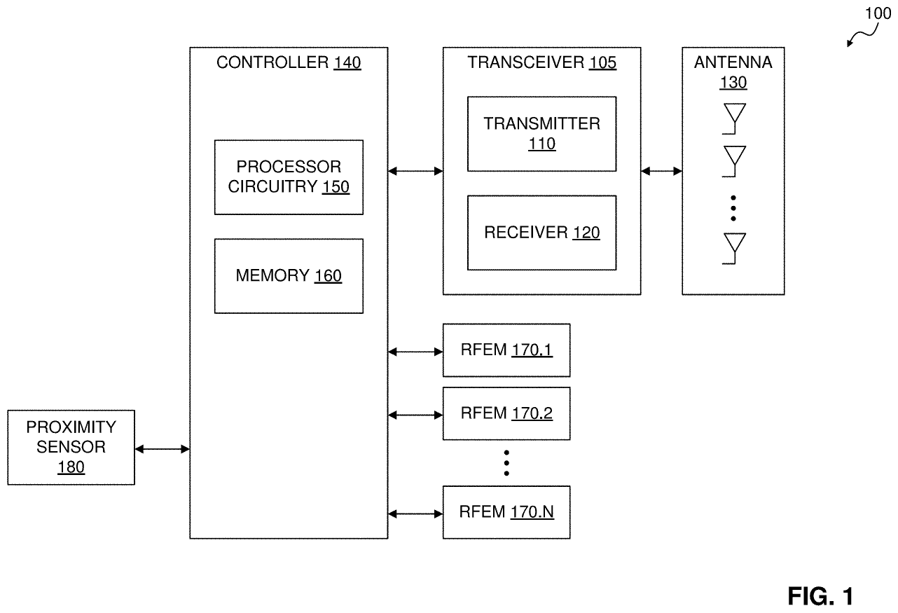

FIG. 1 illustrates a mobile device 100 according to an exemplary aspect of the present disclosure. The mobile device 100 is configured to transmit and/or receive wireless communications via one or more wireless technologies. For example, the mobile device 100 can be configured for wireless communications conforming to, for example, one or more fifth generation (5G) cellular communication protocols, such as 5G protocols that use the 28 GHz frequency spectrum, and/or communication protocols conforming to the Wireless Gigabit Alliance (WiGig) standard, such as IEEE 802.11ad and/or IEEE 802.11ay that use the 60 GHz frequency spectrum. The mobile device 100 is not limited to these communication protocols and can be configured for one or more additional or alternative communication protocols, such as one or more 3rd Generation Partnership Project's (3GPP) protocols (e.g., Long-Term Evolution (LTE)), one or more wireless local area networking (WLAN) communication protocols, and/or one or more other communication protocols as would be understood by one of ordinary skill in the relevant arts. The mobile device 100 can be configured to communicate with one or more other communication devices, including, for example, one or more base stations, one or more access points, one or more other mobile devices, and/or one or more other devices as would be understood by one of ordinary skill in the relevant arts.

The mobile device 100 can include a controller 140 communicatively coupled to one or more transceivers 105 and one or more remote front end modules (RFEMs) 170. The mobile device 100 can also include one or more proximity sensors 180.

The transceiver(s) 105 can be configured to transmit and/or receive wireless communications via one or more wireless technologies. The transceiver 105 can include processor circuitry that is configured for transmitting and/or receiving wireless communications conforming to one or more wireless protocols. For example, the transceiver 105 can include a transmitter 110 and a receiver 120 configured for transmitting and receiving wireless communications, respectively, via one or more antenna modules 130. In aspects having two or more transceivers 105, the two or more transceivers 105 can have their own antenna module 130, or can share a common antenna module via a duplexer.

The antenna module 130 can include one or more antenna elements forming an integer array of antenna elements. In an exemplary aspect, the antenna module 130 is a phased array antenna that includes multiple radiating elements (antenna elements) each having a corresponding phase shifter. The antenna module 130 configured as a phased array antenna can be configured to perform one or more beamforming operations that include generating beams formed by shifting the phase of the signal emitted from each radiating element to provide constructive/destructive interference so as to steer the beams in the desired direction.

The proximity sensor 180 can be configured to detect the location of one or more nearby objects of the mobile device 100. For example, the proximity sensor 180 can be configured to detect the proximity of the user of the mobile device 100 and/or one or more other objects with respect to the mobile device 100. The proximity sensor 180 can be, for example, a capacitive proximity sensor, an inductive proximity sensor, an infrared proximity sensor, and/or one or more other types of proximity sensors as would be understood by one of ordinary skill in the relative arts. The proximity sensor 180 can include processor circuitry that is configured to detect the location of one or more nearby objects of the mobile device 100.

One or more of the remote front end modules (RFEMs) 170 can be configured to transmit and/or receive wireless communications via one or more wireless technologies. In an exemplary aspect, the RFEM 170 is configured to transmit and/or receive wireless communications using one or more communication protocols that utilize the millimeter wave (mmWave) spectrum (e.g., 24 GHz-300 GHz), such as WiGig (IEEE 802.11ad and/or IEEE 802.11ay) which operates at 60 GHz, and/or one or more 5G protocols using, for example, the 28 GHz frequency spectrum.

The RFEM 170 can include one or more transmitters and receivers configured for transmitting and receiving wireless communications, respectively, via one or more antenna modules. In an exemplary aspect, the RFEM 170 includes a phased array antenna as the antenna module that includes (but it not limited to), for example, 8 radiating elements (antenna elements) each having a corresponding phase shifter. The antenna module of the RI-BM 170 is not limited to 8 antenna elements and can include different numbers of antenna elements.

In an exemplary aspect, the RFEM 170 is configured to perform one or more beamforming scanning operations and one or more beamforming operations that include generating beams formed by shifting the phase of the signal emitted from each radiating element to provide constructive/destructive interference so as to steer the beams in the desired direction.

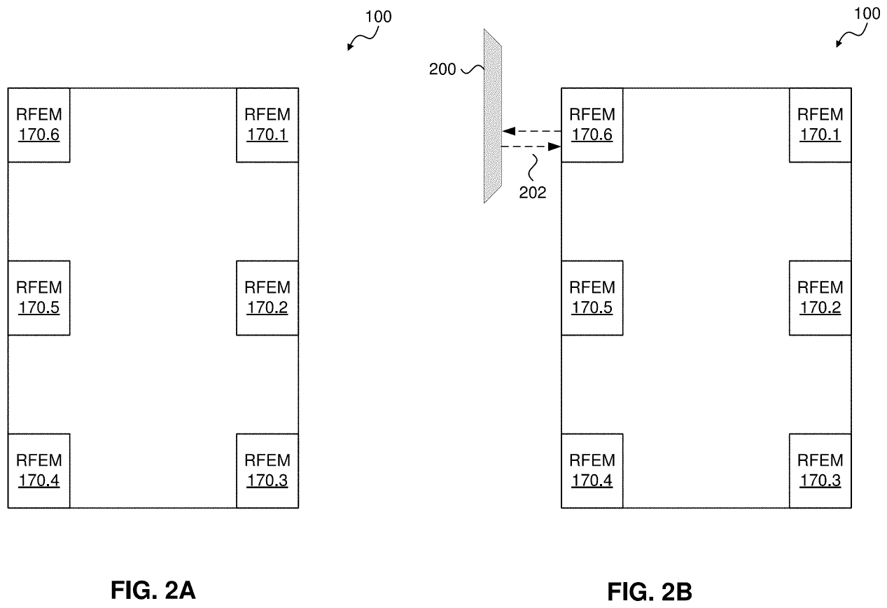

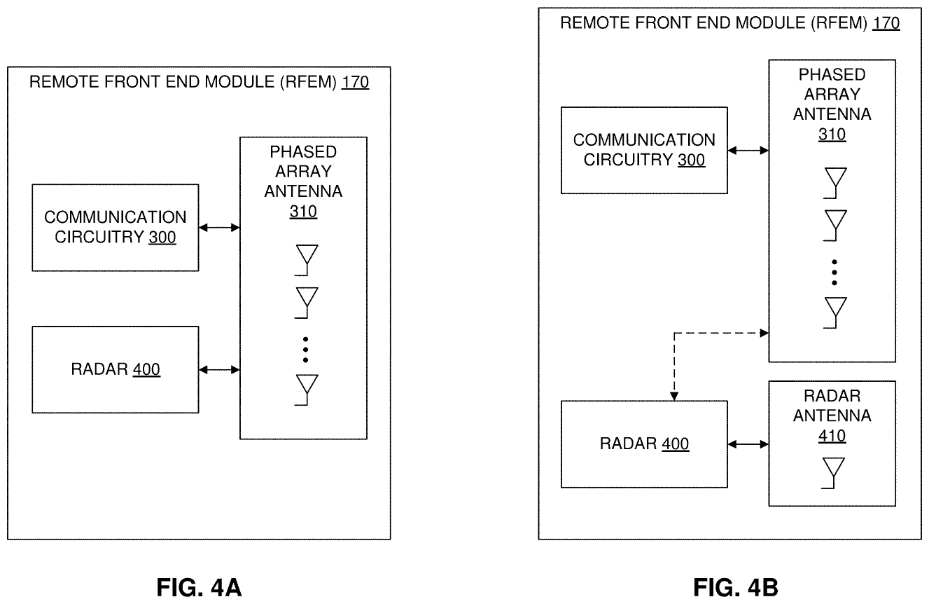

In an exemplary aspect, with reference to FIGS. 2A-2B, the RFBM 170 can be configured to detect or otherwise determine the location of one or more objects (e.g., object 200, which can be, for example, the user of the mobile device 100) to facilitate one or more beamforming scanning operations and/or one or more beamforming operations. For example, as illustrated in FIG. 2B, the object 200 is located near the RFEM 170.6 of the mobile device 100. The RFEM 170.6 can be configured to detect the object 200 based on one or proximity determination signals 202. In this example, the RFBM 170.6 can adjust one or more beamforming scanning operations (e.g., limit or disable the scanning operations by RFEM 170.6) based on the determination of the object's 200 proximity to the RFEM 170.6. In an exemplary aspect, the controller 140 can be configured to control one or more of the RFEMs 170 to determine the proximity of an object. In an exemplary aspect, the RFEM 170 can include one or more proximity detectors or sensors to determine the location of more or more objects. As described in detail with reference to FIGS. 4A-4B, the RFEM 170 can include a radar system (e.g., radar circuitry) configured to determine the proximity of an object.

Returning to FIG. 1, the controller 140 can include processor circuity 150 that is configured to control the overall operation of the mobile device 100, such as the operation of the transceiver(s) 105 and/or the RFEMs 170. The processor circuitry 150 can be configured to control the transmitting and/or receiving of wireless communications via the transceiver(s) 105 and/or the RFEMs 170. In an exemplary aspect, the processor circuitry 150 is configured to control the RFEMs 170 to determine the location of one or more objects and to control one or more beamforming scanning operations and/or one or more beamforming communication operations based on the determination of the object(s). For example, the controller 140 can control beamforming scanning operations for one or more RFEMs 170 based on proximity measurements from one or more of the RFEMs 170, such as controlling an RFEM 170 having a nearby object to disable or reduce beamforming scanning operations to as to reduce the overall scanning time of the RFEMs 170. In an exemplary aspect, the controller 140 can be configured to receive proximity measurement information from one or more RFEMs 170 and control the RFEM(s) 170 to adjust their respective beamforming scanning operations based on the received proximity measurement information.

The processor circuitry 150 can also be configured to perform one or more baseband processing functions (e.g., media access control (MAC), encoding/decoding, modulation/demodulation, data symbol mapping; error correction, etc.). The processor circuitry 150 can be configured to run one or more applications and/or operating systems; power management (e.g., battery control and monitoring); display settings; volume control; and/or user interactions via one or more user interfaces (e.g., keyboard, touchscreen display, microphone, speaker, etc.).

The controller 140 can further include a memory 160 that stores data and/or instructions, where when the instructions are executed by the processor circuitry 150, controls the processor circuitry 150 to perform the functions described herein. The memory 160 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 160 can be non-removable or removable, or a combination of both.

Examples of the mobile device 100 include (but are not limited to) a mobile computing device—such as a laptop computer, a tablet computer, a mobile telephone or smartphone, a “phablet,” a personal digital assistant (PDA), and mobile media player; and a wearable computing device—such as a computerized wrist watch or “smart” watch, and computerized eyeglasses. In some aspects of the present disclosure, the mobile device 100 may be a stationary communication device, including, for example, a stationary computing device—such as a personal computer (PC), a desktop computer, a computerized kiosk, and an automotive/aeronautical/maritime in-dash computer terminal.

In one or more aspects, the mobile device 100 or one or more components of the mobile device 100 can be additionally or alternatively configured to perform digital signal processing (e.g., using a digital signal processor (DSP)), modulation and/or demodulation (using a modulator/demodulator), a digital-to-analog conversion (DAC) and/or an analog-to-digital conversion (ADC) (using a respective DA and AD converter), an encoding/decoding (e.g., using encoders/decoders having convolution, tail-biting convolution, turbo, Viterbi, and/or Low Density Parity Check (LDPC) encoder/decoder functionality), frequency conversion (using, for example, mixers, local oscillators, and filters), Fast-Fourier Transform (FFT), preceding, and/or constellation mapping/de-mapping to transmit and/or receive wireless communications conforming to one or more wireless protocols and/or facilitate the beamforming scanning operations and/or beamforming communication operations.

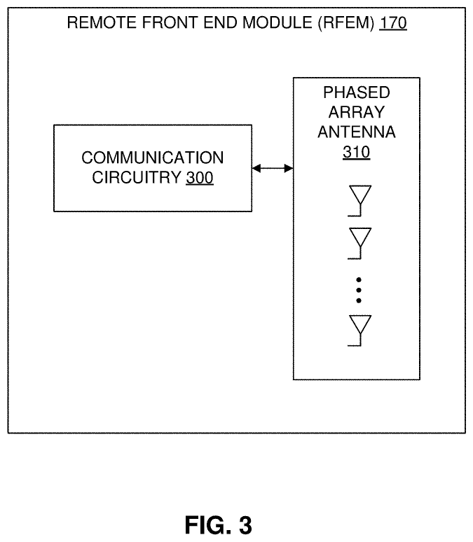

Turning to FIG. 3, an exemplary aspect of the RFEM 170 is illustrated. As shown in FIG. 3, the RFEM 170 can include communication circuitry 300 communicatively coupled to phased array antenna 310.

The communication circuity 300 can be configured to control the overall operation of the RFIM 170 and control one or more communication functions of the RFEM 170. The communication circuitry 300 can be configured to transmit and/or receive wireless communications conforming to one or more wireless technologies using the phased array antenna 310. In an exemplary aspect, the communication circuitry 300 includes processor circuitry configured to perform one or more operations and/or functions of the communication circuitry 300, including transmitting and/or receiving wireless communications conforming to one or more wireless technologies using the phased array antenna 310.

In an exemplary aspect, the RFEM 170 is configured to transmit and/or receive wireless communications using one or more communication protocols that utilize the millimeter wave (mmWave) spectrum (e.g., 24 GHz-300 GHz), such as WiGig (IEEE 802.11ad and/or IEEE 802.11ay) which operates at 60 GHz, and/or one or more 5G protocols using, for example, the 28 GHz frequency spectrum.

The communication circuitry 300 can be configured to perform digital signal processing (e.g., using a digital signal processor (DSP)), modulation and/or demodulation (using a modulator/demodulator), a digital-to-analog conversion (DAC) and/or an analog-to-digital conversion (ADC) (using a respective DA and AD converter), an encoding/decoding (e.g., using encoders/decoders having convolution, tail-biting convolution, turbo, Viterbi, and/or Low Density Parity Check (LDPC) encoder/decoder functionality), frequency conversion (using, for example, mixers, local oscillators, and filters), Fast-Fourier Transform (FFT), preceding, and/or constellation mapping/de-mapping to transmit and/or receive wireless communications via the phased array antenna 310, including facilitating one or more beamforming scanning operations and/or beamforming communication operations.

The phase array antenna 310 can include one or more radiating elements (antenna elements) each having a corresponding phase shifter. For example, the antenna 310 can include (but is not limited to), 8 radiating elements having a corresponding phase shifter.

The RFEM 170 can perform one or more beamforming scanning operations and one or more beamforming communication operations using the communication circuitry 300 in cooperation with the phased array antenna 310. The beamforming scanning and/or communication operations can include generating beams formed by shifting the phase of the signal emitted from each radiating element to provide constructive/destructive interference so as to steer the beams in the desired direction.

FIG. 4A is an exemplary aspect of the RFEM 170 similar to the aspects of the RFEM 170 illustrated in FIG. 3, but further includes radar circuitry 400 that is also communicatively coupled to the phased array antenna 310.

The radar circuitry 400 is configured to determine the proximity of an object. The radar circuitry 400 is configured to detect or otherwise determine the location of one or more objects (e.g., object 200, which can be, for example, the user of the mobile device 100) to facilitate one or more beamforming scanning operations and/or one or more beamforming operations. In operation, the communication circuity 300 can adjust one or more beamforming scanning operations (e.g., limit or disable the scanning operations by RFBM 170) based on the determination of the object's proximity to the RFEM 170. In an exemplary aspect, the radar circuitry 400 includes processor circuitry configured to perform one or more operations and/or functions of the radar circuitry 400, including detecting or otherwise determining the location of one or more objects.

The communication circuity 300 can be configured to improve the scanning time and utilization of scanning resources for the RFEM 170, including perform selective beamforming scanning of the antenna elements of the phased array antenna 310 based on the detection of one or more objects/people determined using the radar circuitry 400. The selective scanning based on the proximity detection can improve (e.g., reduce) the scanning time and/or scanning resources necessary to facilitate communications using the RFBM 170. In exemplary aspects, the radar circuitry 400 is configured to perform one or more radar operations to detect an object. Because radar operations require significantly less time than the time needed for beamforming scanning, the utilization of radar detection can significantly reduce the overall beamforming scanning time be reducing or eliminating unnecessary beamforming scanning with only minimal time cost for the radar detection scanning

In an exemplary aspect, the radar circuitry 400 is configured to radiate one or more signals using the phased array antenna 310 and the echo or the reflected signal produced by a target (e.g., proximate object) can be received via the phased array antenna 310 and sensed by the radar circuitry 400.

In an exemplary aspect, the radar circuitry 400 is configured to emit low level radiation, such as low level radiation in a band that complies with Federal Communications Commission (FCC) or other federal governmental agency regulations (e.g., industrial, scientific, and medical radio band (ISM band) bands like 24 GHz or 61 GHz).

In an exemplary aspect, the radar circuitry 400 is configured to determine the nature of the echoed signal to determine information about the target including range, size of the target/object, material composition of the target/object, etc. The radar circuitry 400 is configured to perform proximity measurements in multiple directions and can determine which antenna element(s) of the phased array antenna 310 and/or which RFEM 170 are blocked by the proximate object, and the directions in which those phased array antenna elements are impacted by the object. In an exemplary aspect, the radar circuitry 400 is configured to perform proximity measurements along an angular range from the RFEM 170, such as in a sector sweeping operation, to determine one or more angles at which detected object is located with respect to the RFEM 170.

With that information, the radar circuitry 400 can be configured to adjust the beamforming scanning operations of one or more RFEMs 170 of the mobile device 100. For example, the radar circuitry 400 can control which antenna elements of a particular RFEM 170 and/or which RFEMs 170 are to participate in beamforming scanning operations and/or adjust one or more scanning characteristics of the antenna elements of the RFEMs 170. For example, the radar circuitry 400 can adjust the duration of the scan, directions at which the scanning is performed, antenna elements to include in/exclude from the scanning operations, RFEMs 170 to include in/exclude from the scanning operations, the power of the radiated signals used in the scanning operations, and/or one or more other scanning characteristics as would be understood by one of ordinary skill in the relevant arts.

In an exemplary aspect, the radar circuitry 400 can be configured to adjust the beamforming scanning operations of one or more RFEMs 170 of the mobile device 100 based on proximity measurements obtained by one or more proximity sensors 180 in additional to or alternative to proximity measurements obtained by the radar circuitry 400. In an exemplary aspect, the controller 140 of the mobile device 100 is configured to control one or more RFEMs 170 to adjust the beamforming scanning operations of one or more RFEMs 170 based on the proximity measurements obtained by the radar circuitry 400 and/or on proximity measurements obtained by one or more proximity sensors 180.

In an exemplary aspect, the communication circuitry 300 is configured to adjust one or more signal characteristics of communication signals generated by the RFEM 170 based on proximity measurements obtained by the radar circuitry 400. For example, the communication circuitry 300 can be configured to adjust the gain of the phased array antenna 310 to electronically redirect the communication signal(s), and/or adjust the transmit power and/or redistribute the transmit power to a different RFBM 170 of the mobile device 100 to avoid the blocking object. These operations can be used to ensure compliance with Specific Absorption Rate (SAR) regulations. Not only does this solution afford compliance with SAR regulations, but it provides a method to avoid the reduction in the radiated power efficiency that would otherwise be incurred by radiating energy into a blocking object. In an exemplary aspect, additionally or alternatively to the communication circuitry 300, the controller 140 of the mobile device 100 is configured to adjust one or more signal characteristics of communication signals generated by the RFEM 170 based on proximity measurements obtained by the radar circuitry 400 and/or proximity measurements obtained by one or more proximity sensors 180.

In an exemplary aspect, the radar circuitry 400, the communication circuitry 300, or a combination of both components can be configured to control the operation of RFEM 170 to selectively perform the communication operations and the radar operations (i.e., whether the RFEM 170 is operating in communication mode or a radar mode). In an exemplary aspect, the controller 140 of the mobile device 100 including the RFEMs 170 can additionally or alternatively be configured to control the operating mode of one or more of the RFEMs 170. For example, the controller 140 can be configured to manage and control the operation of the RFEM 170.

FIG. 4B is an exemplary aspect of the RFEM 170 similar to the aspects of the RFEM 170 illustrated in FIG. 4A, but further includes a dedicated radar antenna 410. In this aspect, the radar circuitry 400 is communicatively coupled to the radar antenna 410 instead of phased array antenna 310. In this example, the radar circuitry 400 is configured to radiate one or more signals using the radar antenna 410 and the echo or the reflected signal produced by a target (e.g., proximate object) can be received via the radar antenna 410 and sensed by the radar circuitry 400. In an exemplary aspect, as represented by the dashed signal path, the radar circuity 400 can additionally be coupled to the phased array antenna 310, and the radar circuitry 400 can be configured to selectively use the radar antenna 410, the phased array antenna 310, or a combination of both to transmit and receive radar signals.

In an exemplary aspect, the radar antenna 410 can include one or more radiating elements (antenna elements). In an exemplary aspect, the radar antenna 410 can include one or more antenna elements configured for transmitting radar signals and one or more antenna elements configured to receive echoed or reflected signals. In an exemplary aspect, the radar antenna 410 can be configured such that transmit and receive communications share one or more antennas. In this example, the radar antenna 410 (or the radar circuitry 400) can include a duplexer configured to communicatively couple the shared antenna element(s) to the transmitter and receiver of the radar circuitry 400.

FIG. 5A illustrates a RFEM 500 that includes radar circuitry 550 and circuitry for radio frequency (RF) conversion to/from an intermediate frequency (IF) according to exemplary aspects of the present disclosure. This configuration is similar to the RFEM 170 illustrated in FIG. 4A. The radar circuitry can be an exemplary aspect of the radar circuitry 400.

The RFEM 500 includes phased array antenna module 510 that includes a number of antenna elements, each of which can be connected through a switch matrix 515 to transmit and receive chains of the RFEM 500. In this configuration, each antenna element can be dynamically configured for transmitting or receiving.

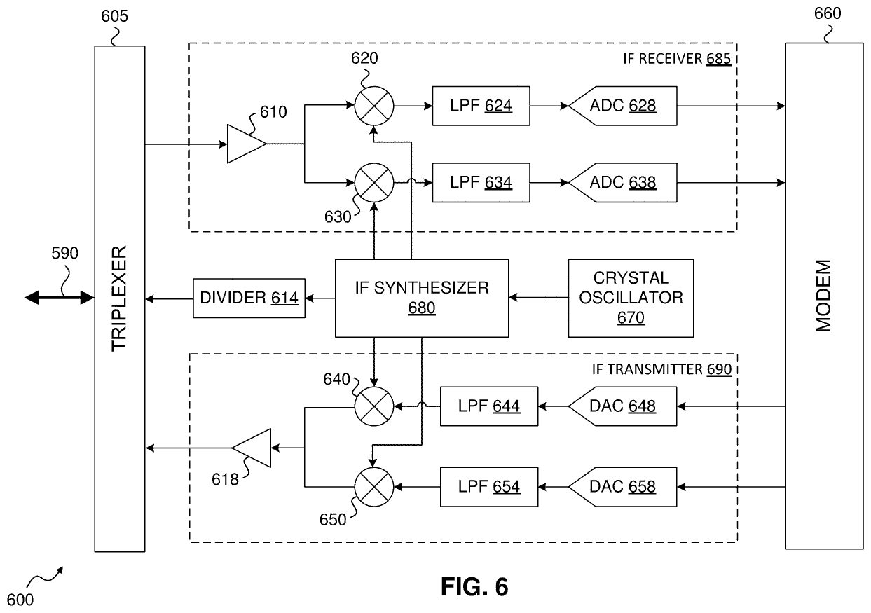

In the receiving chain, the transmit/receive (TX/RX) switch matrix 515 is connected to a bank of Low Noise Amplifiers (LNA) 520 and a bank variable phase shifters 530. The outputs of the phase shifters 530 are added together in the RF combiner 540. The output of the combiner 540 is further amplified by the RF amplifier 560, passed to the down conversion mixer 562 via switch 561, down converted to the IF frequency by the down conversion mixer 562 and further amplified by the IF amplifier 564. The down converted IF signal can then be passed through the triplexer 585 to, for example, a baseband transceiver for a RFEM, such as the baseband transceiver illustrated in FIG. 6 (discussed in detail below) that include circuitry for IF conversion to a baseband frequency (BF). The RFEM 500 can be coupled to the baseband transceiver by communication path 590. Filtering stages that may be introduced in one or more places within the receiving chain are not shown.

The triplexer 585 also feeds the IF transmit signal from the baseband module (e.g., baseband transceiver in FIG. 6). The IF transmit signal is amplified through the IF amplifier 574, up converted through the up conversion mixer 572, passed to the RF amplifier 570 via switch 571, and amplified by the RF amplifier 570. Further, the RF transmit signal is split into a plurality of transmit signal paths by the RF splitter 545. In operation, each transmit signal path is adjusted by the phase shifters 535 and passed through RF power amplifiers 525. The amplified RF transmit signals are then passed through the TX/RX switch matrix 515 to be radiated by elements in the phased array antenna 510. As with the receive path, filtering may be introduced anywhere along the transmit chain and is not shown.

The circuitry also includes a Local Oscillator (LO) signal generator 580 that generates a LO signal based on a reference signal. The reference signal can be derived from the baseband transceiver via the triplexer 585. The IF LO amplifiers 568 and 578 amplify the LO signal to an appropriate level to drive the mixers 562 and 572. In an exemplary aspect, the RFEM 500 can include dedicated antenna elements directly connected to the LNAs 520 and the power amplifiers 525 and omit the switch matrix 515.

In an exemplary aspect, the switch matrix 515, LNAs 520, phase shifters 530, RF combiner 540, amplifiers 525, phase shifters 535, RF splitter 545, LO signal generator 580 and IF LO amplifiers 568 and 578 can be collectively referred to as a radio frequency integrated circuit (RFIC). In an exemplary aspect, the RFIC can include the radar circuitry 550. The RFIC is not limited to these components and the RFIC can collectively refer to a subset of these components and/or include one or more additional or alternate components.

The radar circuitry 550 can be connected to the transmission and the receive paths via switch 571 and switch 561, respectively. During a radar operation, the switch 571 is configured to select the radar circuitry 550 (up position relative to the drawing) to connect the transmitter of the radar circuitry 550 to the amplifier 570. The amplified transmitted radar signal(s) are then split into a plurality of transmit signal paths by the splitter 545. Each radar transmit signal path is adjusted by the phase shifters 535 and passed through power amplifiers 525. The amplified radar transmit signals are then passed through the TX/RX switch matrix 515 to be radiated by elements in the phased array antenna 510. Similarly, the switch 561 is configured to select the radar circuitry 550 (down position relative to the drawing) to connect the receiver of the radar circuitry 550 to the amplifier 560. An echoed and/or reflected radar signal is received by one or more antenna elements in the phased array antenna 510 and passed to LNAs 520 via the switch matrix 515. The received signal is then passed to the of bank variable phase shifters 530. The outputs of the phase shifters 530 are added together in the combiner 540. The output of the combiner 540 is further amplified by the amplifier 560 and passed to the receiver of the radar circuitry 550 via the switch 561.

In operation, the switches 561 and 571 can be set to allow the phased array antenna 510 and the RFEM circuitry to be used by either the communication system (e.g., communication circuitry 300 illustrated in FIG. 4A) or the radar circuitry 550 (e.g., radar circuitry 400 in FIG. 4A). By configuring the phase array antenna 510 to be used by both the communication system and the radar system, a considerable reduction in hardware can be achieved.

In an exemplary aspect, the radar circuitry 550 (radar circuitry 400), the communication circuitry 300, or a combination of both components can be configured to control the selective operation of the RFEM 500 to selectivity perform communication operations and the radar operations (i.e., whether the RFEM 500 is operating in communication mode or a radar mode), including the operation of the switches 561 and 571. In an exemplary aspect, the controller 140 of the mobile device 100 including one or more RFEMs can additionally or alternatively be configured to control the operating mode of one or more of the RFEMs. For example, the controller 140 can be configured to manage and control the operation of the RFEM.

In an exemplary aspect, any combination of the LNAs 520, phase shifters 530, amplifier 560, amplifier 570, phase shifters 535, and/or power amplifiers 525 can be enabled/disabled during one or more radar and/or communication operations. For example, the transmitted radar signal generated by the radar circuitry 550 can be passed to the phased array antenna 510 without amplification and/or phase shift adjustments, and/or echoed and/or reflected radar signals received by one or more antenna elements in the phased array antenna 510 can be passed to radar circuitry 550 without amplification and/or phase shift adjustments.

FIG. 5B illustrates a RFEM 501 that includes radar circuitry 550 similar to the exemplary aspects of RFEM 500 illustrated in FIG. 5A, but includes a dedicated radar antenna 511. This configuration is similar to the RFEM 170 illustrated in FIG. 4B.

Although shown as a separate component, the radar antenna 511 can alternatively be implemented within the phased array antenna 510 as an antenna element within the phased array antenna 510 but dedicated to radar signal operation. The radar antenna 511 can be of a similar material, size and position within the wireless communication device (RFEM 501) as the antenna elements of the phased array antenna 510 or the phased array antenna 510 itself. In an exemplary aspect, the radar circuitry 550 can be of a similar material, size and position within the wireless communication device (RFEM 501) as the RFIC or other components of the communication circuitry of the RFEM 501 (e.g., communication circuitry 300).

As illustrated in FIG. 5B, the radar circuitry is a separate component within the RFEM 501 similar to the aspects illustrated in FIG. 4B, but is not limited to such a configuration. For example, the radar circuitry 550 can be implemented within the RFIC or one or more other components of the communication circuitry of the RFEM 501 (e.g., communication circuitry 300). In one or more exemplary aspects, the additional radar antenna 511 and radar circuitry 550 can be included within the RFEM 501 with little or no additional cost and/or minimal physical footprint within the hardware configuration.

In one or more exemplary aspects, and with reference to FIGS. 4A-5B, a phased array radar can be implemented to cover some or all directions with inexpensive components and with a minimal physical foot print. The phased array radar being described below in various aspects uses similar devices as a wireless communication system. This allows for the practical incorporation and re-use of material, RF components, and antennas which will reduce the implementation cost. Further, by using the same phased array antenna, the radar can emulate the operating conditions that exist while communicating which may impact one or more beamforming scanning operations using the phased array antenna. The radar circuitry (400, 550) can be configured to determine the location of the radiated object (e.g., object 200) and/or the directivity of the radiated object.

FIG. 6 illustrates a baseband transceiver 600 for a RFEM (e.g., RFEM 500/501) including circuitry for IF conversion to/from a baseband frequency (BF) according to an exemplary aspect of the present disclosure.

The triplexer 605 is configured to interface with the triplexer 585 of the RFIC (e.g., of RFEMs 500/501 illustrated in FIGS. 5A and 5B) via the communication path 590. The triplexer 605 can be configured to pass a reference signal (from divider 614) and a transmit signal (from the IF transmitter 690) to the RFIC of RFEMs 500/501, and also be configured to receive the down converted IF signal from the amplifier 564 of the RFIC illustrated in FIGS. 5A and 5B (using the IF receiver 685). The received signal is passed through IF amplifier 610 and down-converted by down-conversion mixers 620 and 630. The down-converted signals can then be filtered by the low pass filters (LPFs) 624 and 634, and converted through the Analog-to-Digital Converters (ADC) 628 and 638, respectively.

The receive signal paths through down-conversion mixers 620 and 630 correspond to the in-phase (I) and quadrature (Q) signal components of the received signal, respectively. These signals are passed to baseband modem 660 for further processing.

The baseband modem 660 can be configured to also generate one or more baseband transmit signals which is passed to the IF transmitter 690. The baseband signal(s) can then be converted to analog through the Digital-to-Analog Converters (DAC) 648 and 658, and filtered by the low pass reconstruction filters 644 and 654. The respective filtered signals can then be up-converted by the up-conversion mixers 640 and 650. The In-Phase (I) and Quadrature-Phase (Q) signal components from the up-conversion mixers 640 and 650 are added and amplified through the IF amplifier 618 and finally passed to the RFIC (e.g., RFEMs 500/501) through the triplexer 605 via the communication path 590.

The local oscillator signals can be generated by crystal oscillator 670 and the IF synthesizer 680. The reference signal is generated from the IF synthesizer 680 through the frequency divider 614 and passed to the RFIC (RFEMs 500/501) through the triplexer 605 via the communication path 590.

FIGS. 5A/5B and 6 together illustrate a representative phased array wireless communication system according to exemplary aspects of the present disclosure. The present disclosure is not limited to these configurations and a phased array wireless communication system can include one or more variations that include, for example, a digital IF architecture or a direct conversion architecture. The functionality can be divided into various modules (the exemplary aspects in FIGS. 5A/5B and 6 is divided into a baseband module (FIG. 6) and an RF module (FIGS. 5A/5B)), or it can be combined together without using triplexers and the communication path 690 to communicate between modules. The RF, IF and baseband devices can also be combined into multiple Integrated Circuits (ICs) in a number of different ways or can be all combined into a single IC.

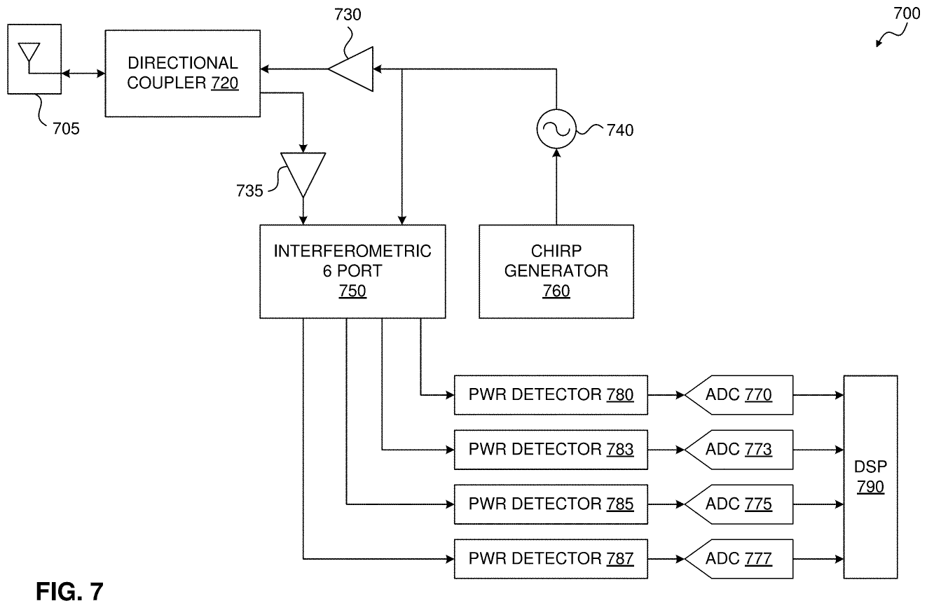

FIG. 7 illustrates radar system 700 according to an exemplary aspect of the present disclosure. The radar system 700 can be an exemplary aspect of the radar circuitry 400 (and corresponding antenna system) as illustrated in FIGS. 4A and 4B, and/or of the radar circuitry 550 (and corresponding antenna system) as illustrated in FIGS. 5A and 5B.

As an overview of radar operation, a signal is first radiated from an antenna. The signal radiates outwardly in space until it encounters an object. The radiated wave is scattered (i.e., a portion of the radiation enters or is transmitted through the object and a portion of the radiation is reflected by the object). The amount of radiated energy that is absorbed or transmitted through the object and how much radiated energy is reflected by the object depends on the characteristics of the object such as the size of the object, the shape of the object and the material composition of the object. The radiated energy that is reflected back towards the transmitter can be referred to as back scatter. The reflected signal or scattered signal is received by the radar system and processed. This processing involves the extraction of information from the reflected signal, including, for example, reflected power, range, Doppler information, and/or one or more other signal characteristics as would be understood by one of ordinary skill in the relevant arts.

The radar system 700 can be configured as a Continuous Wave (CW) radar system in one or more exemplary aspects. For CW radar systems, the transmitted signal can be generated by voltage controlled oscillator (VCO) 740 and chirp generator 760. In an exemplary aspect, the transmitted signal is a constant frequency tone generated by the VCO 740 while the chirp generator 760 generates a constant output.

The radar system 700 can include a RF power amplifier 730 that amplifies the output of the VCO 740. The amplified signal is then passed to the antenna 705 via directional coupler 720. In operation, the transmitted carrier wave is reflected back by an object and received via the antenna 710. The antenna 710 can include one or more radiating elements (antenna elements).

The received reflected signal is passed through the directional coupler 720 to the low noise amplifier (LNA) 735. The amplified output of the LNA 735 and the output of the VCO 740 are connected to passive interferometric six port device 750, which can be configured to add the input signals from the VCO 740 and the LNA 735 at, for example, four relative phase offsets and generate an output for each offset. The phases offsets are not limited to four, and can be another quantity as would be understood by one of ordinary skill in the art. The phase offsets can be (but are not limited to), for example, 0, 90, 180 and 270 degrees. The generated phase offset output signals can be provided to corresponding power detectors 780, 783, 785, and 787.

Depending on the phase difference between the output of the VCO 740 and the reflected signal, each output of the six port device 750 will constructively or destructively add by varying quantities. The power detectors 780, 783, 785, and 787 can each be configured to detect the power of a respective signal from the six port device 750 and generate an output signal corresponding to the detected power. The output of the power detectors 780, 783, 785, and 787 is then provided to a corresponding analog-to-digital converter (ADC) 770, 773, 775, and 777, which converts the power detected output signal to a corresponding digital signal. The digital signals are then provided to digital signal processor (DSP) 790 that is configured to determine the phase difference of a respective signal from the six port device 750 based on the digital signals from the ADCs (e.g., the digital representations of the detected power of the corresponding signals from the six port device 750).

The DSP 790 can be configured to determine a range from the phase difference between the transmitted signal and the reflected signal. The DSP 790 can also measure the strength of the reflection to determine a degree to which a blocking object is present. For example, the reflected signal may be stronger if an object is closer to the transmitter and objects is large and therefore reflects more energy. This information may be used to determine if the particular RFBM is blocked. In an exemplary aspect, the radar system 700 can include one or more filters to adjust the frequency selection and sensitivity of the radar system 700.

In an exemplary aspect, the blocking object may reside within the near field radiation pattern of the antenna 705. In this case, the antenna 705 will exhibit a different driving point impedance as seen by the transmitter. The transmit wave will then be reflected by the mismatched impedance which can also serve as a method to determine if a blocking object is present.

The directional coupler 720 is configured to isolate the transmit and receive signals. This isolation is used so that the transmitter and the receiver of the radar system 700 can operate simultaneously and at the same frequency. The directional coupler 720 can provide isolation to reduce or eliminate the transmit signal inferring with (e.g., bleeding through to) the receive path and being mistaken for a reflected signal. That is, the directional coupler 720 separates or isolates the transmit and receive signals based on the direction of energy flow. In an exemplary aspect, the directional coupler 720 is a parallel line coupler, a 90-degree hybrid coupler, a circulator, or another coupling device that provides directional isolation as would be understood by one of ordinary skill in the relevant arts.

In an exemplary aspect, the radar system 700 is a Continuous Wave Frequency Modulated (CWFM) radar system instead of a CW radar system.

In operation, the chirp generator 760 of the CWFM radar system 700 generates a ramping “chirp” which frequency modulates the transmitted signal. The round trip time required for the transmit signal to propagate to the target object, reflect and propagate back to the receiver is called the time of flight. The range to the target is then known from the time of flight and the speed at which the signal propagates (e.g., the speed of light for RF radiation in free space). In this example, the reflected signal will return oscillating at the same frequency it was transmitted. Because the frequency of the VCO 740 increases or ramps at a constant rate during the time of flight, there is a direct relationship between the time of flight and the frequency change between the received frequency and the transmit frequency. The DSP 790 can determine the range to the target based on a comparison of the current frequency of the VCO 740 and the reflected signal frequency. For the purpose of this disclosure, a “return” signal refers to any reflection, scattering, near field coupling, or any other such signal that is identified from a transmit radiated signal of a device. In one or more exemplary aspects, the radar system 700 can be implemented as the radar circuitry of an RFEM (e.g., as radar circuitry 400, 550)

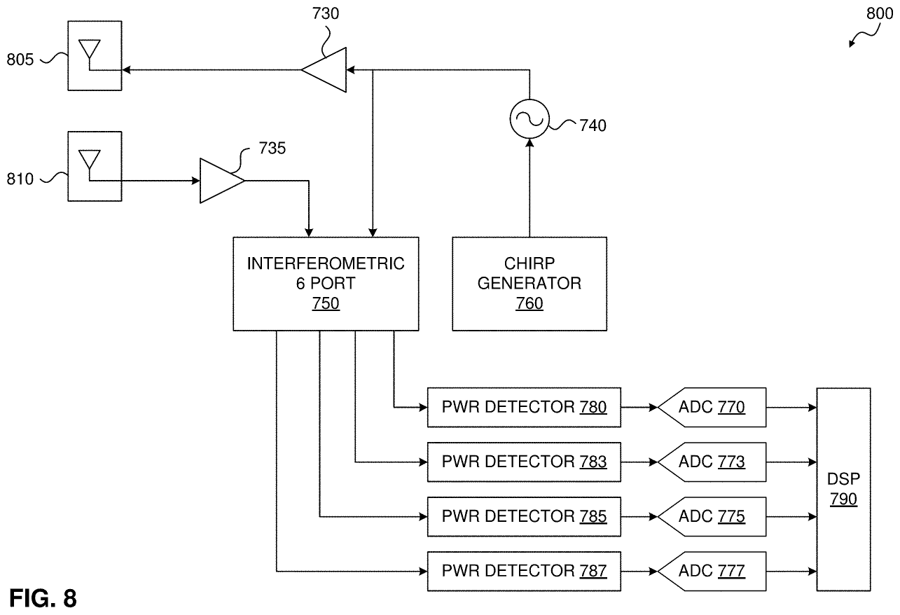

FIG. 8 illustrates radar system 800 according to an exemplary aspect of the present disclosure. The radar system 800 is similar to the radar system 700 but includes one or more separate transmit antennas 805 and one or more separate receive antennas 810 instead of a signal antenna 705 shared by both the transmit and receives paths via directional coupler 720. The antenna 805 and/or the antenna 810 can each include one or more radiating elements (antenna elements).

As illustrated in FIG. 8, rather than using a directional coupler 720 to isolate the transmit and receive signals, a separate transmit antenna 805 and receive antenna 810 are used. In this example, the antenna characteristics and arrangement/separation can be adjusted to provide sufficient isolation.

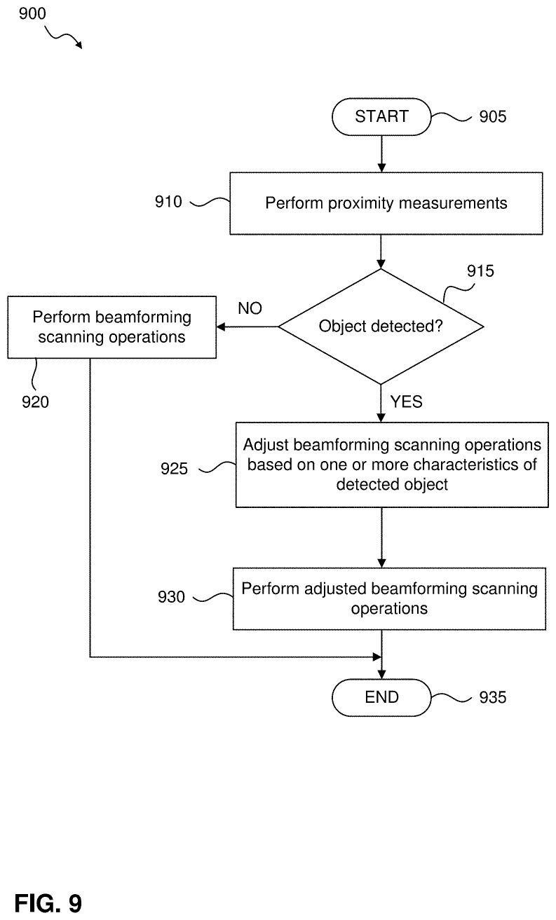

FIG. 9 illustrates a flowchart of scanning method 900 according to an exemplary aspect of the present disclosure is illustrated. The flowchart is described with continued reference to FIGS. 1-8. The operations of the method are not limited to the order described below, and the various operations may be performed in a different order. Further, two or more operations of the method may be performed simultaneously with each other. The scanning method 900 can be performed sequentially or in parallel (e.g., simultaneously) for some or all of the RFEMs of a mobile device. For example, one or more operations of the method can be performed in parallel for two or more RFEMs, such as proximity measurements (operation 910) can be performed for two or more RFEMs in parallel.

The method of method 900 begins at operation 905 and transitions to operation 910, where one or more proximity measurements are performed. For example, one or more RFEMs 170 (e.g., radar circuitry 400/550) can be configured to perform one or more proximity measurements to determine whether a corresponding phase array antenna 130 is blocked by an object (e.g., object 200).

After operation 910, the flowchart 900 transitions to operation 915. If an object is detected by a RFEM 170 (YES at operation 915), the flowchart 900 transitions to operation 925, where one or more beamforming scanning operations are adjusted based on the proximity measurements. The beamforming scanning operations can be adjusted based on one or more characteristics of the detected object that are determined form the proximity measurements. In an exemplary aspect, one or more RFEMs 170 and/or controller 140 of the mobile device 100 can be configured to adjust one or more beamforming operations based on proximity measurements.

After operation 925, the flowchart 900 transitions to operation 930, where one or more adjusted beamforming scanning operations are performed (based on the proximity measurements). In an exemplary aspect, one or more RFEMs 170 and/or controller 140 of the mobile device 100 can be configured to perform the one or more adjusted beamforming operations.

After operation 930, the flowchart 900 transitions to operation 935, where the flowchart 900 ends. The method/flowchart may be repeated one or more times for one or more RFEMs and/or one or more subsequent beamforming scanning operations to provide some examples.

If an object is not detected by a RFEM 170 (NO at operation 915), the flowchart 900 transitions to operation 920, where one or more beamforming scanning operations are performed (based on the proximity measurements). In an exemplary aspect, the scanning operations can be performed without adjustment as in operation 925. In this example, the non-adjusted scanning operations can be referred to normal, default, traditional, or non-adjusted scanning operations to provide some examples. In an exemplary aspect, one or more RFEMs 170 and/or controller 140 of the mobile device 100 can be configured to perform the one or more beamforming operations.

After operation 920, the flowchart 900 transitions to operation 935, where the flowchart 900 ends. The method/flowchart may be repeated one or more times for one or more RFEMs and/or one or more subsequent beamforming scanning operations to provide some examples.

### EXAMPLES

Example 1 is an apparatus of a wireless communication device, the apparatus comprising: radar circuitry configured to perform one or more proximity measurements; and communication circuitry configured to: adjust one or more beamforming scanning operations based on the one or more proximity measurements; and perform the adjusted one or more beamforming scanning operations.

In Example 2, the subject matter of Example 1, wherein the radar circuitry is configured to: to transmit a transmit radiated signal; and detect a return signal generated based on the transmit radiated signal to perform the one or more proximity measurements.

In Example 3, the subject matter of Example 1, wherein the communication circuitry performs the adjusted one or more beamforming scanning operations using a phased array antenna.

In Example 4, the subject matter of Example 3, wherein the radar circuitry performs the one or more proximity measurements using the phased array antenna.

In Example 5, the subject matter of Example 1, further comprising: a phased array antenna coupled to the communication circuitry, wherein the communication circuitry performs the adjusted one or more beamforming scanning operations using the phased array antenna; and a radar antenna independent from the phased array antenna and coupled to the radar circuitry, wherein the radar circuitry performs the one or more proximity measurements using the radar antenna.

In Example 6, the subject matter of any of Examples 3-5, wherein the phased array antenna comprises a plurality of antenna elements.

In Example 7, the subject matter of Example 6, wherein adjusting one or more beamforming scanning operations comprises disabling beamforming scanning operations for one or more antenna elements of the plurality of antenna elements.

In Example 8, the subject matter of any of Examples 1-5, wherein the radar circuitry is configured to detect, based on the one or more proximity measurements, whether an object is near the apparatus that may affect one or more beamforming scanning operations or affect one or more communication of the apparatus utilizing the one or more beamforming scanning operations.

In Example 9, the subject matter of any of Examples 1-5, further comprising a controller configured to: control the radar circuitry to perform one or more proximity measurements; and control the communication circuitry to: adjust one or more beamforming scanning operations based on the one or more proximity measurements; and perform the adjusted one or more beamforming scanning operations.

In Example 10, the subject matter of any of Examples 1-5, wherein the apparatus is a remote front end within the wireless communication device.

Example 11 is a beamforming scanning method for a wireless communication device, the method comprising: performing one or more proximity measurements using a radar system of the wireless communication device; adjusting one or more beamforming scanning operations based on the one or more proximity measurements; and performing the adjusted one or more beamforming scanning operations.

In Example 12, the subject matter of Example 11, wherein performing the one or more proximity measurements comprises: transmitting a transmit radiated signal; and detecting a return signal generated based on the transmit radiated signal.

In Example 13, the subject matter of Example 11, wherein performing the adjusted one or more beamforming scanning operations utilizes a phased array antenna.

In Example 14, the subject matter of Example 13, wherein the radar system uses the phase array antenna to perform the one or more proximity measurements.

In Example 15, the subject matter of Example 13, wherein the radar system uses a radar antenna independent from the phased array antenna to perform the one or more proximity measurements.

In Example 16, the subject matter of any of Examples 13-15, wherein the phased array antenna comprises a plurality of antenna elements.

In Example 17, the subject matter of Example 16, wherein adjusting one or more beamforming scanning operations comprises disabling beamforming scanning operations for one or more antenna elements of the plurality of antenna elements.

In Example 18, the subject matter of any of Examples 11-15, further comprising detecting, based on the one or more proximity measurements, whether an object is near the wireless communication device that may affect one or more beamforming scanning operations or affect one or more communication of the wireless communication device utilizing the one or more beamforming scanning operations.

Example 19 is a computer program product embodied on a computer-readable medium comprising program instructions, when executed, causes a processor to perform the method as described in any of Examples 11-15.

Example 20 is an apparatus of a wireless communication device, the apparatus comprising: radar circuitry means for performing one or more proximity measurements; and communication circuitry means coupled to a phase array antenna comprising a plurality of antenna elements, the communication circuity means for: adjusting one or more beamforming scanning operations based on the one or more proximity measurements; and performing the adjusted one or more beamforming scanning operations using the phase array antenna.

In Example 21, the subject matter of Example 20, wherein performing one or more proximity measurements comprises: transmitting a transmit radiated signal; and detecting a return signal generated based on the transmit radiated signal to perform the one or more proximity measurements.

In Example 22, the subject matter of Example 20, wherein adjusting one or more beamforming scanning operations comprises disabling beamforming scanning operations for one or more antenna elements of the plurality of antenna elements.

In Example 23, the subject matter of any of Examples 20-22, wherein the radar circuitry means is further for detecting whether an object is near the apparatus that may affect one or more beamforming scanning operations or affect one or more communication of the apparatus utilizing the one or more beamforming scanning operations based on the one or more proximity measurements.

In Example 24, the subject matter of any of Examples 20-23, further comprising a controlling means for: controlling the radar circuitry means to perform the one or more proximity measurements; and controlling the communication circuitry means to: adjust one or more beamforming scanning operations based on the one or more proximity measurements; and perform the adjusted one or more beamforming scanning operations.

Example 25 is an apparatus comprising means to perform the method as described in any of Examples 11-18.

Example 26 is a communication device comprising processor circuitry configured to perform the method as described in any of Examples 11-18.

Example 27 is an apparatus for use in a wireless communication device, the apparatus comprising processor circuitry configured to perform the method as described in any of Examples 11-18.

Example 28 is an apparatus substantially as shown and described.

Example 29 is a method substantially as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

As will be apparent to a person of ordinary skill in the art based on the teachings herein, exemplary aspects are not limited to communication protocols that utilize the millimeter wave (mmWave) spectrum (e.g., 24 GHz-300 GHz), such as WiGig (IEEE 802.11ad and/or IEEE 802.11ay) which operates at 60 GHz, and/or one or more 5G protocols using, for example, the 28 GHz frequency spectrum. The exemplary aspects can be applied to other wireless communication protocols/standards (e.g., LTE or other cellular protocols, other IEEE 802.11 protocols, etc.) as would be understood by one of ordinary skill in the relevant arts.

1-24. (canceled)

25. An apparatus of a wireless communication device, the apparatus comprising:
radar circuitry configured to perform one or more proximity measurements; and
communication circuitry configured to:
adjust one or more beamforming scanning operations based on the one or more proximity measurements; and
perform the adjusted one or more beamforming scanning operations.

26. The apparatus of claim 25, wherein the radar circuitry is configured to:
to transmit a transmit radiated signal; and
detect a return signal generated based on the transmit radiated signal to perform the one or more proximity measurements.

27. The apparatus of claim 25, wherein the communication circuitry performs the adjusted one or more beamforming scanning operations using a phased array antenna.

28. The apparatus of claim 27, wherein the radar circuitry performs the one or more proximity measurements using the phased array antenna.

29. The apparatus of claim 25, further comprising:
a phased array antenna coupled to the communication circuitry, wherein the communication circuitry performs the adjusted one or more beamforming scanning operations using the phased array antenna; and
a radar antenna independent from the phased array antenna and coupled to the radar circuitry, wherein the radar circuitry performs the one or more proximity measurements using the radar antenna.

30. The apparatus of claim 27, wherein the phased array antenna comprises a plurality of antenna elements.

31. The apparatus of claim 30, wherein adjusting one or more beamforming scanning operations comprises disabling beamforming scanning operations for one or more antenna elements of the plurality of antenna elements.

32. The apparatus of claim 25, wherein the radar circuitry is configured to detect, based on the one or more proximity measurements, whether an object is near the apparatus that may affect one or more beamforming scanning operations or affect one or more communication of the apparatus utilizing the one or more beamforming scanning operations.

33. The apparatus of claim 25, further comprising a controller configured to:
control the radar circuitry to perform one or more proximity measurements; and
control the communication circuitry to:
adjust one or more beamforming scanning operations based on the one or more proximity measurements; and
perform the adjusted one or more beamforming scanning operations.

34. The apparatus of claim 25, wherein the apparatus is a remote front end within the wireless communication device.

35. A beamforming scanning method for a wireless communication device, the method comprising:
performing one or more proximity measurements using a radar system of the wireless communication device;
adjusting one or more beamforming scanning operations based on the one or more proximity measurements; and
performing the adjusted one or more beamforming scanning operations.

36. The method of claim 35, wherein performing the one or more proximity measurements comprises:
transmitting a transmit radiated signal; and
detecting a return signal generated based on the transmit radiated signal.

37. The method of claim 35, wherein performing the adjusted one or more beamforming scanning operations utilizes a phased array antenna.

38. The method of claim 37, wherein the radar system uses the phase array antenna to perform the one or more proximity measurements.

39. The method of claim 37, wherein the radar system uses a radar antenna independent from the phased array antenna to perform the one or more proximity measurements.

40. The method of claim 37, wherein the phased array antenna comprises a plurality of antenna elements.

41. The method of claim 40, wherein adjusting one or more beamforming scanning operations comprises disabling beamforming scanning operations for one or more antenna elements of the plurality of antenna elements.

42. The method of claim 35, further comprising detecting, based on the one or more proximity measurements, whether an object is near the wireless communication device that may affect one or more beamforming scanning operations or affect one or more communication of the wireless communication device utilizing the one or more beamforming scanning operations.

43. A computer program product embodied on a computer-readable medium comprising program instructions, when executed, causes a processor to perform the method of claim 35.

44. An apparatus of a wireless communication device, the apparatus comprising:
radar circuitry means for performing one or more proximity measurements; and
communication circuitry means coupled to a phase array antenna comprising a plurality of antenna elements, the communication circuity means for:
adjusting one or more beamforming scanning operations based on the one or more proximity measurements; and
performing the adjusted one or more beamforming scanning operations using the phase array antenna.

45. The apparatus of claim 44, wherein performing one or more proximity measurements comprises:
transmitting a transmit radiated signal; and
detecting a return signal generated based on the transmit radiated signal to perform the one or more proximity measurements.

46. The apparatus of claim 44, wherein adjusting one or more beamforming scanning operations comprises disabling beamforming scanning operations for one or more antenna elements of the plurality of antenna elements.

47. The apparatus of claim 44, wherein the radar circuitry means is further for detecting whether an object is near the apparatus that may affect one or more beamforming scanning operations or affect one or more communication of the apparatus utilizing the one or more beamforming scanning operations based on the one or more proximity measurements.

48. The apparatus of claim 44, further comprising a controlling means for:
controlling the radar circuitry means to perform the one or more proximity measurements; and
controlling the communication circuitry means to:
adjust one or more beamforming scanning operations based on the one or more proximity measurements; and
perform the adjusted one or more beamforming scanning operations.
